(19) United States
(12) Patent Application Publication
(10) Pub. No.: US 2007/0069417 A1
(43) Pub. Date: Mar. 29, 2007

(54) Sculpture apparatus and method

(76) Inventor: Paul Cassidy, Lancashire (GB)

Correspondence Address: STITES & HARBISON PLLC, 1199 NORTH FAIRFAX STREET, SUITE 900, ALEXANDRIA, VA, 22314, US

(21) Appl. No.: 10/569,086

(22) PCT Filed: Aug. 20, 2004
(86) PCT No.: PCT/GB04/03588

§ 371 Date: Aug. 22, 2006

(30) Foreign Application Priority Data
Aug. 22, 2003 (GB) 0319805.8
Jan. 27, 2004 (GB) 0401737.2
Mar. 11, 2004 (GB) 0405483.9
Apr. 26, 2004 (GB) 0409252.4

(51) Int. Cl. B29C 67/00; B29C 33/40

(52) U.S. Cl. 264/222; 425/2

(57) ABSTRACT

Apparatus for the creation of a sculpture, the apparatus including a base member (2) which may resemble a human skull, the skull having integral guide means including pegs (6) protruding from the skull and holes (4) in the outer surface of the skull for receiving further pegs. The dimensions of the pegs which can be inserted into the holes can be selected with reference to a set of instructions. The prefabricated pegs and inserted pegs guide the apparatus of a modeling medium such as plasticine to create the sculpture.

### TECHNICAL FIELD

The present invention relates to an apparatus and method for creating a sculpture.

### DISCLOSURE OF INVENTION

Creating a sculpture can require substantial skill and experience. The present invention aims to provide an apparatus and method whereby the sculptor can be suitably assisted and/or guided so that the creation of the sculpture is easier. Therefore, at its most general, the present invention provides some sort of base or former on or around which the sculpture is to be created, together with some sort of guide to assist the user in applying the appropriate amount of sculpture material to the base/former in the appropriate places.

The term “sculpture” is intended to include any three dimensional article but particularly relates to articles in which the material varies in thickness in different parts of the article. In one particular example, the sculpture in question is a model of a face or head and in particular the invention could be used to assist the creation of masks, faces, heads or other models. These may be human masks/faces/heads/models and/or maybe those of other animals. The invention is of course also applicable to the creation of other types of models in a similar manner.

Accordingly, more particularly, in a first aspect the present invention provides apparatus for the creation of a sculpture, the apparatus including a base member having guide means integral with the base member to guide the application of a modelling medium to create the sculpture.

The provision of guide means integral with the base member enables the user to quickly and easily build up the modelling medium, for example to pre-determined thicknesses at one or more locations on the base member associated with the guide means. In this way, the user is not required to have any anatomical knowledge and does not need to decide where and to what thickness the modelling medium is to be applied.

The guide means can be locating means by which a plurality of spacer members may be located such that in use each spacer member extends away from the surface of the base member so as to be usable to guide the application of the modelling medium to create the sculpture.

In this way, the spacer members assist the user in applying the modelling medium to the correct areas on and/or in relation to the base member and/or in the correct quantities/thicknesses/shapes.

The modelling medium may be any suitable material such as modelling clay, plasticine etc, and preferably is a material which is malleable when being applied. Preferably the material remains malleable so that the user can take their time creating the sculpture. Alternatively, the modelling medium can set later e.g. in air (or is settable e.g. by the application of heat or a curing agent) to form the sculpture or model.

Alternatively or additionally, the guide means can be spacer members pre-fabricated with the base member. The apparatus can include both pre-fabricated spacer members and locating means.

Thus, in some embodiments the apparatus may include spacer members that are pre-formed in their respective locations. One possible way of achieving this is to pre-form the spacer members as part of the base member. For example, the shape of the base member may be such that the parts of the base member extend away from the general surface of the base member so as to form one or more of the spacer members.

A sculpture apparatus having a unitary base member and spacer members is particularly easy for younger children to use.

The spacer members may be pre-moulded with the base member. For example, the spacer members and base member can be made from the same mould.

An embodiment in which spacer members are pre-formed or pre-fixed may be particularly suitable for relatively simple sculptures, in which perhaps the number of spacer members required to guide the user is relatively few, for example in a sculpture toy aimed at younger children. Aspects of these different embodiments could of course be combined into a single embodiment.

The apparatus may also include one or more shaping members. The shaping member(s) is/are fixable to the base member prior to the application of the modelling medium. The function is to “bulk out” the surface of the base member so that the user need apply less modelling medium (or none at all) in order to obtain the desired sculpture. Each shaping member may be rigid, semi-flexible (such as a silicone or rubber type material), deformable or mouldable by the user. Similarly, the shaping member(s) may be solid or hollow. In an example where the base member is a human or animal skull, the shaping members may, for example, be intended to mimic one or more of the major areas of muscle and/or fat which lie on the skull. This helps the user to form more easily a more accurate structure on which to apply the modelling medium so as to more easily obtain the desired end result. One example which may be appropriate for a solid, hollow shaping member is that of a member intended to form the base of a nose on a human skull.

Where the sculpture is a human or animal face or head, one feature which may require increased skill to create well is that of the ears. Accordingly, one example of a shaping member (which is a further aspect of the present invention) is a former to which the modelling medium may be applied in order to more easily create the desired ear shape. Ears (at least the part external to a head, the pinna) of both humans and animals include numerous ridges and folds. Some examples of these parts of the ear are the helix, anti-helix, lobule, anti-tragus and crest of helix. These can be particularly difficult to create accurately with the modelling medium. To assist with the creation of any or all of these features, in some examples the former may include one or more suitably located apertures, either in or passing all the way through the former. By using these apertures to locate the modelling medium, the relevant features may be more easily created. Where the aperture(s) pass all the way through the former, insertion of modelling medium from one side of the former will enable some of the modelling medium to protrude through the apertures to the other side, thereby creating the relevant features.

The shaping members may be fixable to the base member by any suitable means (e.g. by adhesive or modelling medium). One example might be that each shaping member includes means for engaging with one or more of the locating means and/or spacer members. For example, where the locating means are holes (see below), the means for engaging may be protruding members such as pegs or pins that can be inserted into the holes. In another example, where the spacer members are pegs, each shaping member may include one or more holes which are located so as to fit over the appropriate pegs. Preferably, a desired amount of the peg(s) then protrudes through the shaping member, when it is located in the appropriate place, so that the spacer member(s) are still usable to guide the application of the modelling medium by the user. Additionally or alternatively, the spacer members (e.g. pegs) may be insertable through the shaping member(s) whether or not holes are provided in the shaping member be locatable in the locating means.

Preferably the guide means are locating means adapted for location of the spacer members and more preferably the base member includes a plurality of locating means, each locating means being adapted for the location of a respective single spacer member. Preferably each of the locating means and/or also each of the spacer members are labelled in some way (e.g. by use of numbers and/or letters) so that it can be made clear which spacer member is to be located at which locating means. For example, in some commercial embodiments, the user could be supplied with a set of instructions informing him/her where to apply the spacer members to the locating means in order to create a particular desired sculpture.

In one embodiment a base member could include some locating means and some pre-formed or pre-fixed spacer members as well at locations other than where the locating means are located.

Preferably the locating means is one or more specific physical mechanisms suitably adapted to hold respective spacer member(s) in position. Various examples are given below, but in brief suitable locating means could be as simple as one or more holes in the base member or could also be more complex such as one or more screw threaded holes. However, in some embodiments the locating means may simply be a series of markings (e.g. dots) on the surface of the base member indicating suitable locations where the user should place (e.g. insert) each spacer member. This latter embodiment may be particularly suitable where the base member is fabricated from a relatively soft material, such as foam (e.g. a foamed or expanded plastics material), into which spacer members can be readily inserted.

In one embodiment, the base member may be a skull (e.g. a human skull) or part of a skull. The spacer members can then be applied by the user to locating means provided on the skull so as to enable the user to create a face, head or mask on top of the skull. The skull and/or spacer means may be dimensioned and/or located so as to assist the user in the creation of a particular face/head/mask e.g. one of a chosen historical or famous person or a particular animal.

In some embodiments, the location of the spacer members and/or the extent to which each spacer member protrudes away from the surface of the base member may be adjustable or variable. This applies also to pre-fabricated spacer members, as do the following optional features. In the example of the skull given above, this could enable a user to create a number of different heads/faces/masks based on the same skull base member. This type of flexibility could, for example, be provided by a set of instructions informing the user how to rearrange the spacer members. Additionally or alternatively, the user could have a second, different, set of spacer members to apply to the base member.

In some embodiments, as mentioned above, the amount by which each spacer member extends away from the surface of the base member may be variable or adjustable by the user. This could be provided, for example, by inserting each spacer member into or on to the locating means so as to leave a predetermined amount protruding from the base member. Alternatively, where the base member is hollow (or at least where there is access to the inside of the base member), the spacer members could be inserted into locating means from the inside or underside of the base member so that they pass through the thickness of the base member and then protrude out of and away from the outer surface of the base member. Again, in such an example, the distance by which some or all of the spacer members protrude from the base member may be adjustable or variable.

The adjustability of the spacer members could be provided for by providing means whereby they can be screwed into or out of the base member (i.e. a retention means, preferably one retention means per spacer). Additionally, it is desirable that the spacer members lock in position on the base member so that, for example, they cannot move or be pushed into and/or out of the base member while the modelling medium is being applied. For this, each spacer member or locating means may include retention means.

The use of some sort of threaded engagement between each spacer member and the locating means on the base member could be one way of achieving this. An additional or alternative way of achieving this could be to have a part of each spacer member dimensioned so that when a spacer member is in place in or on a locating means, the suitably dimensioned part of the spacer member prevents the spacer member from moving in one or more directions. In an embodiment where the spacer member is inserted from inside the base member, this could be achieved by dimensioning a part of the spacer member so that it cannot pass through the base member. Additionally or alternatively a portion of the spacer member may be moveable (e.g. expandable) by the user so as to reduce or prevent further movement of the spacer. Additionally or alternatively a spacer member may include a flange and/or shoulder which, in use, rests against the surface of the base member preventing further insertion of the spacer member. This is particularly useful if the base member is made from a relatively low density or lightweight material, such as foam.

In one embodiment, as will be seen later in the specification, each locating means is simply a hole located on the outer surface of the base member. Preferably each hole passes all the way through the base member if the base member is hollow. Alternatively, the base member may not be hollow. In conjunction with this embodiment, or otherwise, each spacer member may be an elongate pin or peg e.g. of substantially cylindrical construction. As previously mentioned, each peg may have a head or flange, the dimensions (e.g. diameter) of which may be larger than that of each hole so that, when the pin or peg is inserted through the hole it reaches a predetermined depth and can pass no further.

In use, once the modelling medium has been applied to the base member, for example, so as to be level with the end of each of the spacer members, thereby assisting the definition of the shape and/or surface of the sculpture, the modelling medium can be left to set or cure in some way. Prior to partial or full setting/curing, the spacer members may be removed from the base member. This will be particularly easy in embodiments where the spacer members have been inserted through the base member from its interior side, when spacer members can then simply be withdrawn. This enables the spacer members to be reused and/or makes it easier to remove the sculpture from the base member once it has set. Once the sculpture has set, it can be decorated in any required manner, If removal from the base member is desired (which it may not be in some embodiments), this may be either prior to removal from the base member or afterwards. In the case of the creation of a mask/head/face, the decoration may take the form of painting and/or the application of additional features such as hair, eyes etc.

The base member may be fabricated from any suitable material. In some embodiments (particularly ones where the locating means are e.g. preformed holes or more complex locating means) the base member may be of a relatively hard material such as a plastics material. This may also be suitable where the base member consists of two or more pieces which the user has to fit together and/or is hollow so that the use can insert the locating means from inside the base member and/or is intended to be dismantled so that the finished sculptor can be removed from the base member. In other embodiments, the base member may be made from a relatively soft material, such as foam. This may be suitable where, for example, the locating means are merely a series of markings, or even just a set of instructions, and the spacer members are inserted by the user into the base member without there being any preformed mechanism for receipt of the spacer members.

In a further aspect, the present invention provides apparatus for the creation of a sculpture, the apparatus having a base member and a set of instructions to guide attachment of spacer members to the base member.

The instructions preferably include spacer member location information and spacer member height information to guide the user in inserting the spacer members.

Suitably, spacer members can be inserted into the base member in accordance with the instructions, preferably the base member is made of a relatively soft material such as foam.

The optional and preferred features of the other aspects also apply to this aspect.

In another aspect the present invention provides apparatus for the creation of a sculpture, the apparatus including a base member into which spacer members can be inserted.

Preferably, the base member is made of a deformable material. Suitably the base member is made of a relatively soft material such as foam. Foamed, blown or expanded plastics materials, e.g. expanded polystyrene, may be used to make the base member.

The optional and preferred features of the other aspects also apply to this aspect.

In a further aspect, the present invention provides a sculpture kit including a base member as described above together with a plurality of spacer members also as described above. The kit may include a suitable modelling medium and/or suitable shaping member(s).

In a yet further aspect, the present invention provides a method for creation of a sculpture including the step of applying modelling medium to a base member having guide means integral with the base member to guide the application of the modelling medium.

The method preferably includes the step of locating a plurality of spacer members on the base member which has locating means adapted for location of the spacer members, such that each spacer member extends away from the surface of the base member so as to be usable to guide the application of a modelling medium to create the sculpture.

The method may also include the step of applying modelling medium to a base member having spacer members integral with the base member.

The present invention also includes methods of making an apparatus for the creation of a sculpture as described herein.

Other preferred steps of the method will be apparent from the description above.

Optional and/or preferred features of any one or more aspects may apply to any other aspect.

### BRIEF DESCRIPTION OF DRAWINGS

Preferred embodiments of the present invention will now be described by way of example with reference to the accompanying drawings in which:

FIG. 1 shows an embodiment of the present invention in which the base member is a part of a human skull.

FIG. 2 is a partial section through FIG. 1.

FIG. 3 is a further embodiment of the present invention in which the base member is a horse skull.

FIG. 4 shows the embodiment of FIG. 1 after the spacer members have been located in the skull.

FIG. 5 shows the embodiment of FIG. 4 with the modelling medium partially applied.

FIG. 6 shows the embodiment of FIG. 1 after the modelling medium has been applied and while the spacer members are being removed.

FIG. 7 shows the removal of the sculpture from the base member for the embodiment of FIG. 1.

FIG. 8 shows a further embodiment of the present invention with a solid base member.

FIG. 9 shows the embodiment of FIG. 8 (although it would also be applicable to other embodiments) with various shaping members applied to the base member.

FIG. 10 shows the front view of a shaping member for use in the modelling of a human ear.

FIG. 11 shows the rear view of the shaping member of FIG. 10.

### DESCRIPTION OF EMBODIMENTS OF THE INVENTION

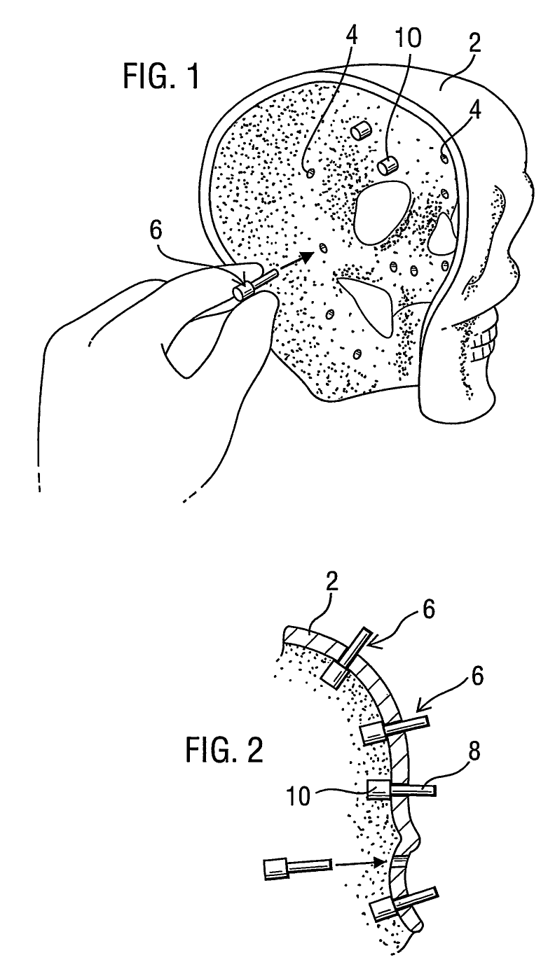

In one of the preferred embodiments of the invention, the aim is to assist the user in the creation of sculptures which are essentially faces, masks or heads. To this end, as seen in FIG. 1, the base member 2 is a moulding in the shape of all or part of a human skull. This may be the skull of a specific person or species and also may be divided into parts for easy assembly/disassembly or alternatively may be solid. For example, the skull may be bisected into front and rear sections, and the front section can be seen in FIG. 1 as viewed from behind.

The skull 2 is provided with a plurality of apertures 4 (locating means) integral with the skull, in this case in the front section of the skull. Only a relatively small number of apertures 4 are shown in FIG. 1 but a substantial number may be provided to better assist the user in the creation of the desired sculpture. Spacer members in the form of pegs 6 can be inserted from behind the apertures 4 (one per aperture) so as to protrude out of the skull 2, as can be seen more clearly in FIG. 2.

In the example shown in FIG. 2, each peg 6 consists of a body portion 8 which is dimensioned so as to pass through a hole 4, and a head portion 10 which is dimensioned so as not to pass through a hole 4. In this way, the peg 6 can be pushed through the hole 4 until the head 10 rests against the inside surface of the skull 2, thereby preventing the peg from moving any further.

Additional means may be provided to lock each peg in place. In one example of such means, each plug may be constructed in such a way that the portion which has passed through the hole and protrudes from the front surface of the skull, is expandable (e.g. laterally or radially) in some way. This expansion would prevent the plug from being pushed back through the hole until the user had re-contracted the relevant portion. Such expansion/contraction could be achieved by providing each plug with an inner core which when pushed along the length of the plug expands that part of the plug which is exposed at the front of the skull.

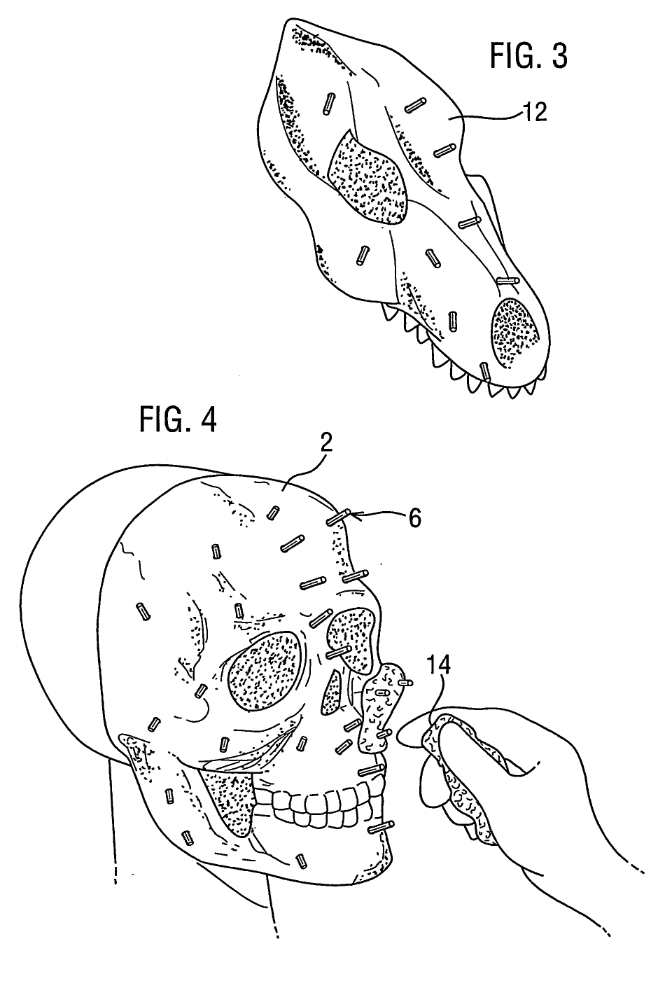

The above example has been described with reference to the use of a model of a human skull as the base member but, as can be seen in FIG. 3, other base member models could be used, in this case a model of a horse skull 12.

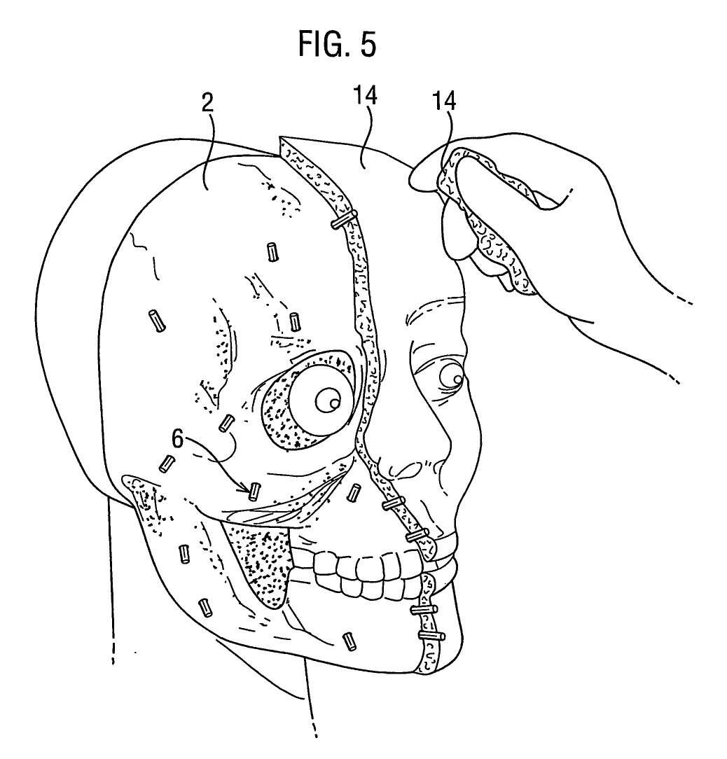

FIG. 4 shows a front view of the skull 2 with a number of pins 6 in place so that modelling medium 14 (e.g. clay) can be applied to the outer surface of the skull 2. The intention is that the user will apply the modelling medium 14 so that it covers the pins 6 thereby assisting the user in creating the desired face on the skull. A partially completed face can be seen in FIG. 5.

As previously mentioned, some or all of the pins 6 may be pre-fixed in place or even pre-formed as part of the base member e.g. the skull 2. This is not shown in FIG. 4.

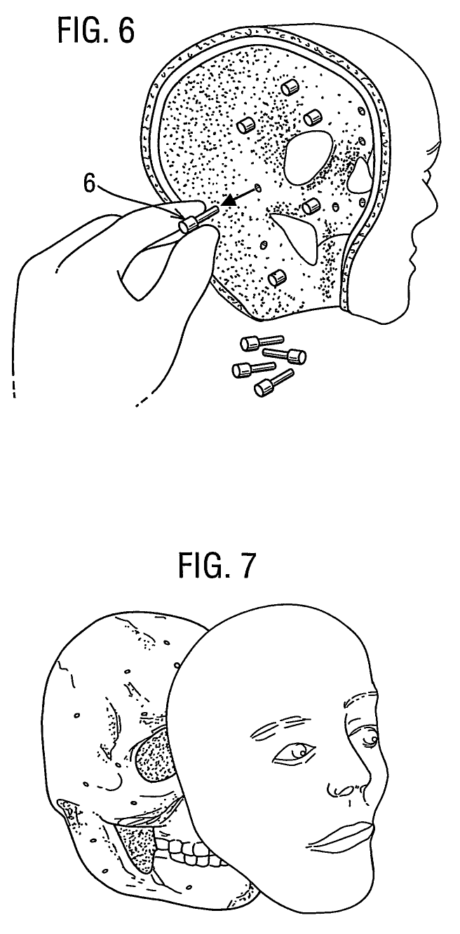

After completion of the desired sculpture (in this case a face), at some time prior to total setting of the sculpture material, the pins 6 are removed, as seen in FIG. 6. This enables the pins to be reused and/or facilitates removal of the completed sculpture from the base member, as seen in FIG. 7.

As mentioned previously, many modifications or variations on the above embodiment are contemplated. For example, the holes provided in the skull 2 may not pass completely through the skull, depending on how the product is to be used and/or the structure of the pegs 6. Each hole position may be chosen for a particular anatomical significance and/or may be identified in a suitable way e.g. with numbering and/or lettering. Similarly, the pegs may be labelled e.g. with numbering and/or lettering so that the user can locate the correct peg in or on the correct hole, either from the rear/inside or the front of the skull, depending on the embodiment. The pegs 6 may have a predetermined length or may be adjustable so that a predetermined desired length protrudes from the skull.

Multiple sets of pegs could be provided for a single skull, so as to create different faces based on the same skull. Additionally or alternatively, multiple skulls could be provided which utilise the same set of pegs, again so as to enable the user to create different sculptures. Where the same set of pegs is used for multiple skulls, the pegs are not necessarily used in the same holes in each case.

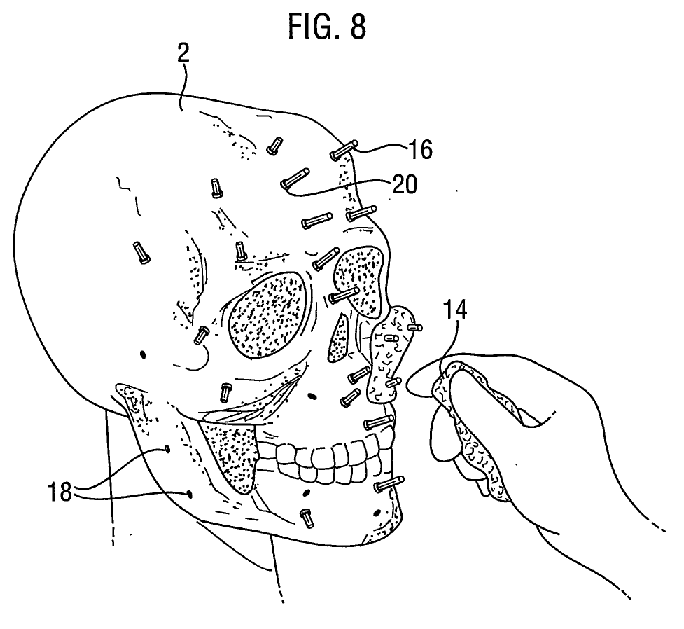

FIG. 8 shows a further embodiment of the present invention in which the base member is a solid member, rather than hollow as in the previously described embodiment. In this embodiment, the spacer members 16 are each inserted into a respective hole in the base member 2, which holes may have been preformed in the base member or alternatively may simply be made by the act of insertion of the spacer member. Clearly each spacer member 16 is inserted from the outside of the base member. Where the holes are not preformed in the base member, the locations of the spacer members may be predetermined e.g. by marking suitable locations on the base member (for example with dots, as shown as items 18) or by providing a suitable set of instructions.

Preferably, each spacer member is provided with suitable means to prevent it from being inserted into the base member further than is required. In this example, the means consist of a flange 20 on each spacer member. As can be seen in FIG. 8, once each spacer member has been inserted into the base member by the appropriate distance, the flange 20 rests against the surface of the base member thereby preventing further insertion of the spacer member.

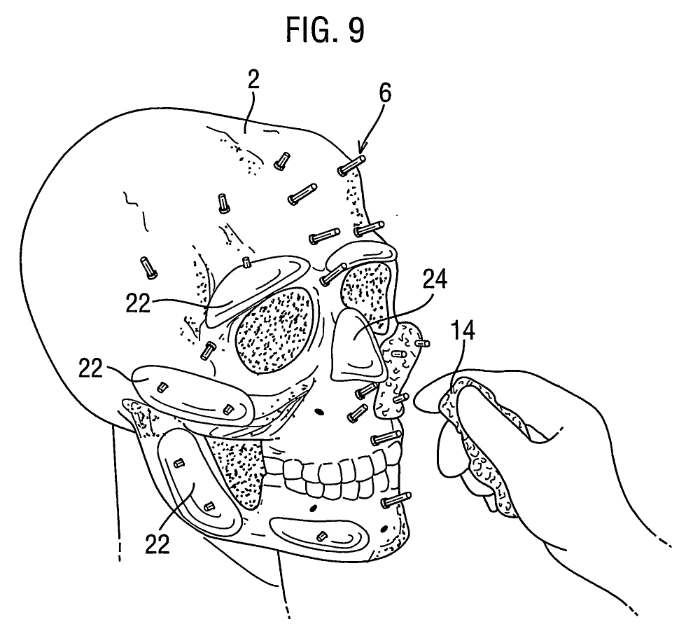

The above embodiments of spacer member may of course be applied to embodiments using other types of base member e.g. a hollow base member as previously described. The same applies to the description of the spacing members below, which may also be used in conjunction with other types of base members than the one described in FIG. 9.

FIG. 9 shows the base member of FIG. 8 to which various shaping members have been applied. Several of the shaping members 22 are intended to mimic areas of fat or muscle which underlie the sculptor to be created (in this case a human head). In this embodiment, the shaping member 22 are applied over the top of the spacer members 20 so that the spacer members 20 help to hold the shaper members 22 in place on the base member 2. Part of the spacer members 20 still protrude through the shaping members 22, when in place, so that they can still be of assistance to the user when applying the modelling medium appropriately. In alternative embodiments, as previously described, the shaping members 22 may be applied to the base member 2 before the spacer members 20 are inserted and the spacer members 20 may then be inserted through the shaping members 22 into the base member 2. Again, preferably, a suitable amount of spacer member 20 will be left protruding from each shaping member 22.

FIG. 9 also shows a different type of spacer member, in this case a nose armature 24. This may be solid or, for example, may be hollow or cage-like. Again, the aim is to assist the user by providing a suitable base shape, for, in this case, a human nose to which the modelling medium 14 may then be applied more accurately.

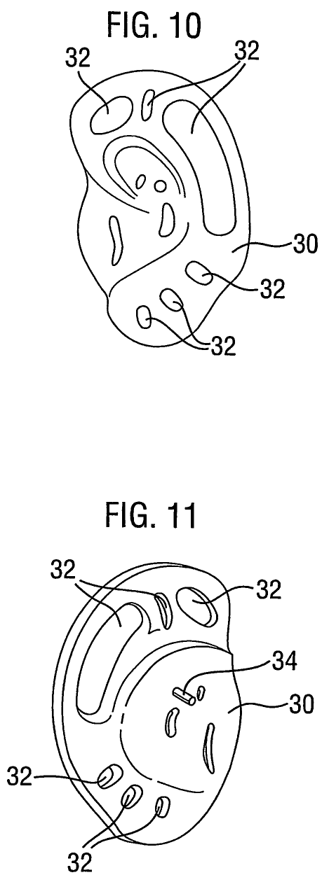

FIG. 10 shows the front view of an embodiment of a shaping member according to the present invention. This particular shaping member is intended to assist in the sculpting of a human ear, but similar principles may be applied to other shaping members for other desired sculpture parts. The shaping member includes a former 30, which may be made of a suitably stiff or rigid material such as metal or plastic. The former 30 may be substantially flat or may be of varying thickness so as to further assist in the creation of the ear sculpture.

The former 30 includes a plurality of apertures, examples of which are labelled 32. In this particular embodiment, the apertures pass all the way through the former 30, as is further illustrated in FIG. 11 which shows a view of the reverse side of the former 30. The intention is that the user will apply the modelling medium to the former 30 and that, with suitable pressure from the user, some of this modelling medium will be forced through the apertures 32. By forcing the modelling medium through the apertures 32, suitable ridges (and therefore troughs) will be created as the modelling medium emerges on the side of the former opposite to that from which it was inserted. In this example, the modelling medium may be inserted from the rear of the former, thereby emerging through the apertures on the front side, creating suitable ridges on the front side.

The former may also include one or more spacer members (in this example, one spacer member 34 is shown) to assist either the location of the shaping member on the sculpture base member or the application of suitable amounts of modelling medium or both.

It is to be understood that variants of the above described examples of the invention in its various aspects, such as would be readily apparent to the skilled person, may be made without departing from the scope of the invention in any of its aspects.

1. Apparatus for the creation of a sculpture, the apparatus including a base member having guide means integral with the base member to guide the application of a modelling medium to create the sculpture.

2. Apparatus according to claim 1, wherein the guide means includes locating means by which a plurality of spacer members may be located, such that in use each spacer member extends away from the surface of the base member so as to be usable to guide the application of a modelling medium to create the sculpture.

3. Apparatus according to claim 2 wherein the base member includes a plurality of locating means, each locating means being adapted for the location of a single spacer member.

4. Apparatus according to claim 3 wherein each of the locating means and also each of the spacer members are labelled so that each spacer member can be associated with a given locating means.

5. Apparatus according to any one of claims 2 to 4, wherein the location of the spacer members and/or the extent to which each spacer member protrudes away from the surface of the base member is adjustable or variable.

6. Apparatus according to claim 5 wherein a user can access the inside of the base member, and the spacer members are insertable into locating means from the inside or underside of the base member so that in use they pass through the base member and then protrude out of the outer surface of the base member.

7. Apparatus according to any one of the claims 2 to 6, wherein each spacer member or locating means includes retention means so that the spacer members can be locked in position on the base member.

8. Apparatus according to any one of claims 2 to 7, wherein part of each spacer member is dimensioned so that when a spacer member is in place in or on a locating means, the suitably dimensioned part of the spacer member prevents the spacer member from moving in one or more directions.

9. Apparatus according to any one of the claims 2 to 8, wherein each spacer member is provided with a flange or shoulder which, in use, limits the amount by which it can be inserted into the base member.

10. Apparatus according to any one of the claims 2 to 9, wherein a portion of each spacer member may be moveable by the user so as to reduce or prevent further movement of the spacer member.

11. Apparatus according to any one of the claims 2 to 10, wherein each locating means is a hole located on the outer surface of the base member or passing all the way through the base member.

12. Apparatus according to any one of claims 2 to 11, in which the locating means includes one or more markings on the surface of the base member.

13. Apparatus according to any one of claims 1 to 12, wherein the guide means includes pre-fabricated spacer members that extend away from the surface of the base member so as to be usable to guide the application of a modelling medium to create the sculpture.

14. Apparatus according to claim 13 wherein the pre-fabricated spacer members are moulded integrally with the base member.

15. Apparatus according to any one of the preceding claims, including a shaping member fixable to the base member to guide the application of a modelling medium to create the sculpture.

16. Apparatus according to claim 15, wherein the shaping member is flexible and can be deformed to adapt to the surface of the base member.

17. Apparatus according to claim 15 or 16, wherein the shaping member is hollow.

18. Apparatus according to any one of claims 15 to 17, wherein the shaping member is intended to form the base of a nose or an ear.

19. Apparatus according to any one of claims 15 to 18, wherein the shaping member includes one or more apertures to guide the application of the modelling medium

20. Apparatus according to claim 19, wherein the apertures pass all the way through the shaping member.

21. Apparatus according to any one of claims 15 to 20, wherein the shaping member includes means for engaging with the base member.

22. Apparatus according to claim 21, wherein the means for engaging includes a peg or pin.

23. Apparatus according to claim 21 or 22, wherein the means for engaging includes one or more holes.

24. Apparatus according to claim 23, wherein the holes are through holes to permit a spacer member to protrude through the shaping member.

25. A sculpture kit including a base member according to any one of the above claims and a plurality of spacer members.

26. A sculpture kit according to claim 25, including a set of instructions informing the user where to place the spacer members on the base member.

27. A sculpture kit according to claim 25 or claim 26, including modelling medium.

28. A method for creation of a sculpture including the step of applying modelling medium to a base member, which base member has guide means integral with the base member, the guide means being usable to guide the application of modelling medium to create the sculpture.

29. The method of claim 28, including the step of locating a plurality of spacer members on the base member, the guide means of the base member including locating means adapted for location of the spacer members, such that each spacer member extends away from the surface of the base member so as to be usable to guide the application of a modelling medium to the base member.

30. A method according to claim 28 or claim 29, wherein the base member has pre-fabricated spacer members integral with the base member.

31. A method of making a sculpture apparatus according to any one of claims 1 to 24 including the step of providing guide means integral with the base member.
